(19) United States
(12) Patent Application Publication
(10) Pub. No.: US 2012/0080291 A1
(43) Pub. Date: Apr. 5, 2012

(54) SENSOR DOOR WITH SLIDING RUB BLOCK

(76) Inventors: Bradley D. Slye, Plymouth, MN (US); Matthew J. Small, Crystal, MN (US)

(21) Appl. No.: 12/896,997

(22) Filed: Oct. 4, 2010

(51) Int. Cl. B65G 21/20; E06B 7/00

(52) U.S. Cl. 198/836.1; 49/70

(57) ABSTRACT

A sensor door with sliding rub block includes a pair of slots in the door through which mounting hardware is inserted to couple a rub block to the door. The slots enable the rub block to move relative to the door. A central slot between the pair of slots enables a sensor to be coupled to the rub block and move with the rub block.

### BACKGROUND

I. Field of the Invention

The present invention relates generally to sensors and more particularly to movable sensors.

II. Description of the Related Art

It is desirable in conveyor systems to monitor the side-to-side position of the conveyor belts to prevent heat build-up due to belt misalignment and possible damage to the belt and/or other components of the system. Sensors can be positioned at the edges of the conveyor belt. If the belt moves too far to either side of the roller or drive components, the sensor detects a rise in temperature from the belt rubbing on the sensor. This temperature increase is then transmitted to either an automatic controller or a human monitor that the belt has shifted and needs to be re-aligned. The belt can then be stopped or moved back into alignment.

One problem with such an arrangement is that locations next to the belt edges are necessary in order to mount the sensors. However, some conveyor systems might not have a clear location next to the belt edges due to the location of other equipment or simply the structure of the conveyor system. Accordingly, there is a need in the art for a way to mount sensors next to conveyor belts.

### SUMMARY

The present invention encompasses a sensor door with a plurality of slots formed through the door. A temperature conductive rub block is coupled to the door. The rub block is configured to conduct a temperature change to sensor equipment mounted to the door. Mounting hardware attaches the rub block to the door through the plurality of slots such that the rub block is movable relative to the door.

### BRIEF DESCRIPTION OF THE DRAWINGS

FIG. 1 shows a front view of one embodiment of a sensor door having a sliding rub block.

FIG. 2 shows a side exploded view of one embodiment of the sensor door with the sliding rub block.

FIG. 3 shows a rear view of one embodiment of the sensor door with the sliding rub block.

FIG. 4 shows a bottom view of one embodiment of the sensor door with the sliding rub block.

FIG. 5 shows one alternate embodiment of the mounting slots for the rub block.

FIG. 6 shows one embodiment of the sensor door with the sliding rub block of the present invention incorporated into a grain conveyor system.

### DETAILED DESCRIPTION

The sensor door with the sliding rub block can be installed onto conveyor systems (e.g., grain conveyors) and provides a movable sensor that can be re-positioned. The movement of the rub block enables the door to be installed in areas of the conveyor system structure that might not be adjacent to a conveyor belt and then moved relative to the door such that the rub block is adjacent to the belt. If the belt moves out of alignment such that it rubs against the rub block, the friction between the rub block and the belt will cause the rub block temperature to increase. The temperature change is then detected by a temperature sensor mounted to the rub block.

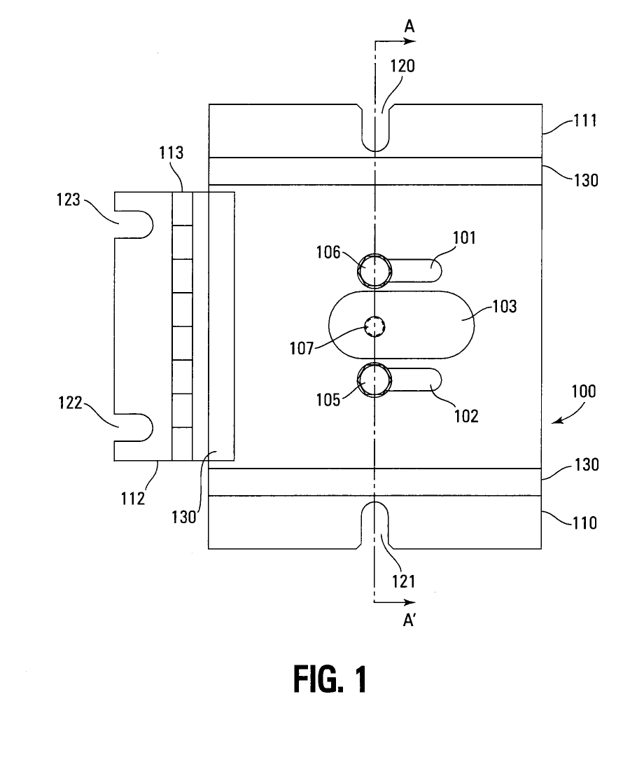

FIG. 1 illustrates a front view of one embodiment of the sensor door 100 with the sliding rub block. The door includes mounting flanges 110-112 that have attachment openings 120-123 through which mounting bolts (not shown) can be inserted for mounting the door 100. The attachment openings 120-123 are elongated to allow the door to be positioned in a desirable location prior to tightening the mounting bolts. For example, the attachment openings 120, 121 allow positioning along the y-axis while the remaining attachment openings 122, 123 allow positioning along the x-axis. A hinge 113 connects the door 100 to the side mounting flange 112. The mounting flanges 110-112 are connected to a door frame 130 around the door 100.

The door 100 includes slots 101, 102 through which bolts 105, 106 or other mounting hardware are inserted for attaching the rub block to the door. A central slot 103, shown between the two mounting slots 101, 102, includes a hole 107 through which a sensor (e.g., temperature probe) can be inserted to be attached to the rub block. The sensor mounting slot 103 can be larger to accommodate the mounting hardware (i.e., conduit, nuts) to hold the sensor to the door 100.

The slots 101-103 illustrated in FIG. 1 are for purposes of illustration only. Alternate embodiments can use different slot arrangements, depending on the application for which the door is to be used. For example, instead of parallel horizontal slots 101-103, the slots might be vertical, angled, or have various arcs/radiuses so that the mounting bolts 105, 106 can be moved over and/or up/down to accommodate different conveyor system structures. Such an arrangement enables the rub block to move horizontally and/or vertically relative to the door.

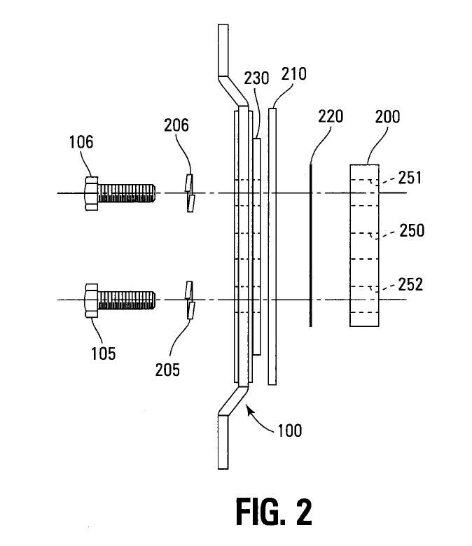

FIG. 2 illustrates a side exploded view, along axis A-A′, of one embodiment of the sensor door 100 with the sliding rub block 200. A gasket 220 is attached to the rub block 200 to prevent the door 100 and/or any hardware on the door 100 from becoming a heat sink and reducing the temperature of the rub block 200. The gasket 220 can be made from paper, rubber, foam or any other material that is a poor conductor of heat.

A gasket 210 is attached to the door 100 for sealing the door 100 when it is closed. The gasket 210 can prevent materials, such as grain particles, from escaping from around the door 100. The gasket 210 can be made of foam, rubber, or some other gasket material.

A spacer 230 is attached to the door 100 to provide separation between the door 100 and the rub block 200. In one embodiment, this is a metal plate that is welded to the door 100. The illustrated embodiment of FIG. 2 shows only one spacer 230. Alternate embodiments might include additional spacers, in addition to the one shown, in order to move the rub block 200 further away from the door 100. Such an embodiment might include a conveyor system in which the belt is further from the mounting structure and, thus, further from the sensor door 100.

The rub block mounting bolts 105, 106 are inserted through the slots in the door 100 and spacer block 230 and attach to (e.g., screw into) the rub block 200. Lock washers 205, 206 can be used to better retain the mounting bolts 105, 106. Additional washers can also be used if the mounting slots in the door are larger than the heads of the mounting bolts 105, 106.

In one embodiment, the rub block 200 is made of a metal that conducts heat well. Alternate embodiments can use other materials that conduct heat. The rub block 200 includes mounting holes 251, 252 for the mounting bolts 105, 106. An additional hole 250 can be used to mount the temperature sensor. In one embodiment, the temperature sensor screws into the mounting hole 250 to provide good contact between the rub block 200 and the sensor.

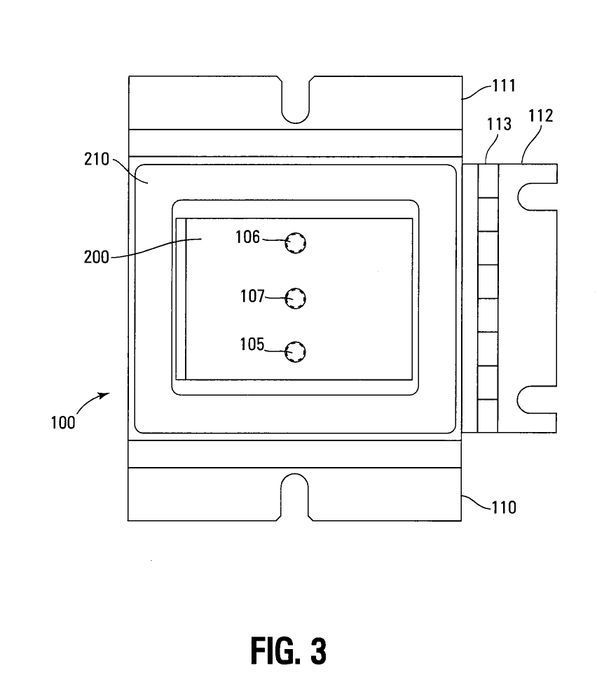

FIG. 3 illustrates a rear view of one embodiment of the sensor door 100 with the sliding rub block 200. This view shows the orientation of the door gasket 210 around the periphery of the door 100 for sealing the door 100 against contaminants. This view also shows the two mounting bolt holes 105, 106 and the sensor hole 107.

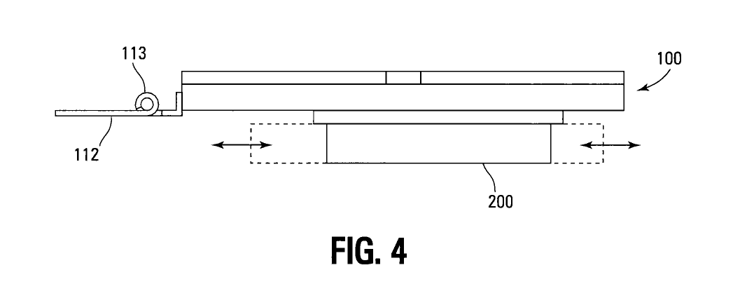

FIG. 4 illustrates a bottom view of one embodiment of the sensor door 100 with the sliding rub block 200. This view illustrates one embodiment of lateral movement back and forth of the rub block.

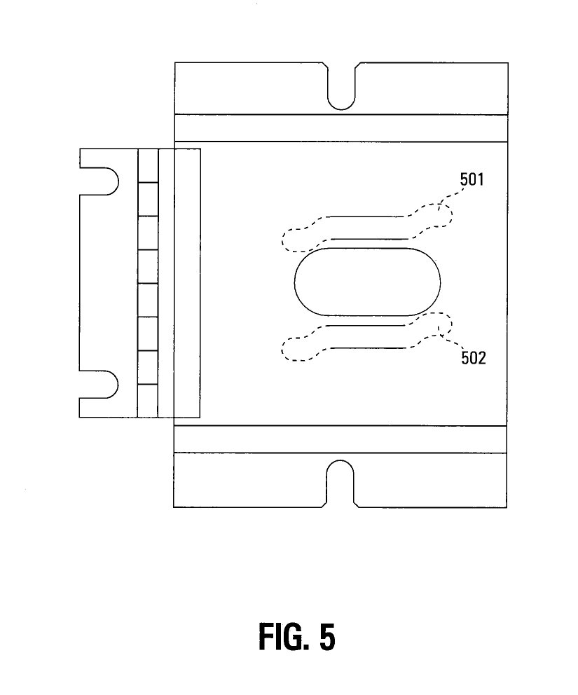

FIG. 5 illustrates one alternate embodiment, as discussed previously, of the mounting slots 501, 502 for the rub block. In this embodiment, the mounting bolts can be moved horizontally prior to moving upward or downward, depending on the desired placement of the rub block. This figure illustrates only one such alternate embodiment.

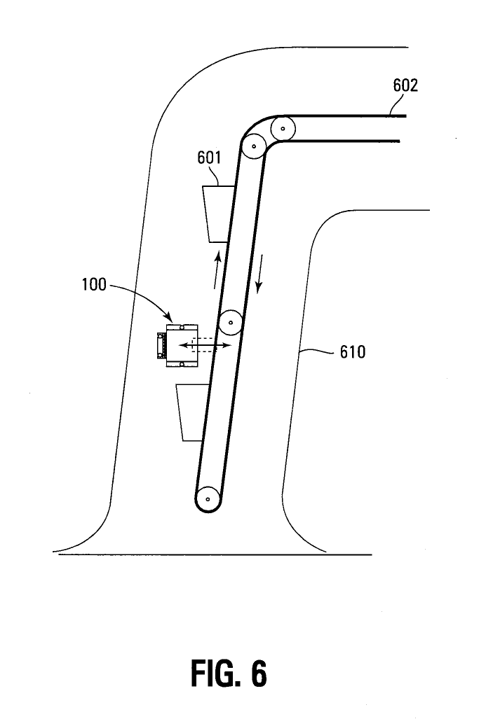

FIG. 6 illustrates one embodiment of a conveyor system that includes the shaft sensor door with sliding rub block 100 of the present invention. However, the present invention is not limited to any one type of conveyor system. Any system requiring monitoring of a belt alignment is encompassed by the present invention.

The illustrated system includes a conveyor belt 602 to which grain buckets 601 are attached to move grain upward. The sensor door 100 is attached to an opening in the conveyor belt supporting structure 610. The rub block can then be moved such that it is adjacent to the belt in order to monitor the alignment of the belt. A second sensor door with rub block can also be mounted on the other side of the supporting structure 610 to monitor both sides of the conveyor belt 602.

When the belt 602 moves too far to one side or the other the resulting friction between the belt 602 and one of the rub blocks causes the rub block temperature to increase which is detected by the temperature sensor coupled to the rub block. Monitoring equipment can then automatically shut down the conveyor system, generate an alarm, or generate some other belt misalignment indication when a certain temperature threshold is reached.

Numerous modifications and variations of the present invention are possible in light of the above teachings. It is therefore to be understood that within the scope of the appended claims, the invention may be practiced otherwise than as specifically described herein.

What is claimed is:

1. A sensor door comprising:
a plurality of slots formed through the door;
a rub block coupled to the door, the rub block configured to conduct a temperature change; and
mounting hardware configured to attach the rub block to the door through the plurality of slots such that the rub block is movable relative to the door.

2. The sensor door of claim 1 wherein the plurality of slots includes a slot through which a temperature sensor is inserted and coupled to the rub block.

3. The sensor door of claim 1 wherein the plurality of slots includes a pair of horizontally parallel slots on either side of a central slot through which a temperature sensor is inserted and coupled to the rub block.

4. The sensor door of claim 1 wherein the mounting hardware comprises a plurality of bolts that are each inserted through a different one of at least two of the slots and connected to the rub block.

5. The sensor door of claim 1 wherein the rub block comprises a metal.

6. The sensor door of claim 3 wherein the central slot is configured to accommodate temperature sensor mounting hardware.

7. The sensor door of claim 4 wherein the mounting hardware further comprises a washer through which each bolt is inserted.

8. A sensor door comprising:
mounting flanges coupled to the door and configured to enable mounting of the door to a structure;
a hinge configured to couple the door to at least one of the mounting flanges;
a central slot configured to accept a temperature sensor;
a pair of slots on either side of the central slot;
a rub block coupled to the door and configured to conduct a temperature change; and
mounting hardware for coupling the rub block to the door wherein the mounting hardware is inserted through the pair of slots to connect to the rub block wherein the rub block is movable relative to the door in response to the pair of slots.

9. The sensor door of claim 8 and further including a gasket mounted between the rub block and the door.

10. The sensor door of claim 9 and further including a spacer coupled to the door and mounted between the gasket and the rub block.

11. The sensor door of claim 8 wherein the mounting flanges comprise attachment openings configured to allow movement of the sensor door prior attachment of the sensor door to a structure.

12. The sensor door of claim 11 wherein the attachment openings comprise elongated openings through which mounting bolts are inserted such that the sensor door is positionable in at least one of two axes.

13. The sensor door of claim 8 and further comprising a door gasket coupled to a periphery of the door and configured to seal the door against a structure to which the door is mounted.

14. The sensor door of claim 8 wherein the pair of slots are configured to enable the rub block to move horizontally and/or vertically relative to the door.

15. A conveyor system comprising:
a supporting structure;
a movable belt that moves within the supporting structure; and
a first sensor door connected to the supporting structure, the sensor door comprising:
a pair of slots formed through the door;
a rub block coupled to the door, the rub block configured to conduct a temperature change;
a sensor inserted through a central slot between the pair of slots and connected to the rub block; and
mounting hardware configured to attach the rub block to the door through the pair of slots wherein the rub block, responsive to the mounting hardware through the pair of slots, is movable relative to the door such that the rub block is positioned adjacent to the movable belt.

16. The conveyor system of claim 15 wherein the sensor is a temperature probe.

17. The conveyor system of claim 15 and further including a second sensor door connected to the supporting structure on an opposing side of the movable belt from the first sensor door.

18. The conveyor system of claim 15 wherein the rub block comprises a conductive material.

19. The conveyor system of claim 17 wherein the first and second sensor doors further comprise a plurality of mounting flanges coupled to three sides of the door wherein the mounting flanges include elongated attachment openings through which attachment hardware is inserted to connect the first sensor door to the supporting structure.

20. The conveyor system of claim 15 wherein the mounting hardware comprises bolts that screw into the rub block and lock washers through which the bolts are inserted.
